(19) United States
(12) Patent Application Publication
(10) Pub. No.: US 2008/0062846 A1
(43) Pub. Date: Mar. 13, 2008

(54) OPTICAL REPRODUCING APPARATUS AND OPTICAL REPRODUCING METHOD

(75) Inventor: Yoshihisa USAMI, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/837,667

(22) Filed: Aug. 13, 2007

(30) Foreign Application Priority Data
Sep. 7, 2006 (JP) 2006-243378

(51) Int. Cl. G11B 7/00

(52) U.S. Cl. 369/103

(57) ABSTRACT

An optical reproducing apparatus and an optical reproducing method for safely viewing a reproduced image by preventing the reproduction beam from the light source from directly entering the eyes of a viewer depending on the visual position of the viewer when holographically recorded information in an optical recording medium, particularly reproducing a transmission type hologram is reproduced. The optical reproducing apparatus has a recorded information reproducing unit configured to reproduce recorded information corresponding to an interference image formed on a recording layer of an optical recording medium by irradiating the interference image with a reproduction beam that is the same as a reference beam used during recording, and a reproduction beam blocking unit configured to block the transmitted reproduction beam that is incident at a specific angle relative to the optical recording medium, which is placed between the viewing position of the reproduced recorded information and the optical recording medium

### BACKGROUND OF THE INVENTION

1. Field of the Invention

The present invention relates to an optical reproducing apparatus and an optical reproducing method that allow for reproducing recorded information on an optical recording medium using holography, and more particularly relates to an optical reproducing apparatus and an optical reproducing method that allow for safely viewing a reproduced image by preventing the reproduction beam from the light source (backlight) from directly entering the eyes of a viewer depending on the visual position of the viewer when a transmission type hologram is reproduced.

2. Description of the Related Art

In an optical reproducing method for reproducing recorded information on an optical recording medium utilizing holography, the information is reproduced by irradiating a reproduction beam that is the same as a reference beam utilized to record on the optical recording medium and in the same direction as during the recording. The light irradiation generates diffracted light from an interference image formed by interference fringes as optical information recorded on the optical recording medium, thereby optical information is reproduced. This type of method for recording the information on an optical recording medium is generally performed by causing an information beam (object beam) having image information and a reference beam to interfere in the optical recording medium and by utilizing interference fringes generated at this time to record on the optical recording medium.

The optical reproducing method differs depending on the type of hologram, and the types of holograms is broadly classified into two major types, i.e., reflection type hologram and transmission type hologram.

The reflection type hologram is a hologram where during hologram reproduction, the diffracted light is output in the opposite direction of the traveling direction of the reproduction beam irradiated toward the hologram, and in this case, the hologram can be reproduced by irradiating the reproduction beam onto the hologram from the side where the viewer is positioned.

The transmission type hologram is a hologram where during hologram reproduction, the diffracted light is generated from transmitted light, and in this case, the hologram can be reproduced by irradiating the reproduction beam from behind the hologram.

In this way, in the case of the reflection type hologram, there exists a problem that light is hardly taken and the reproduced image is hardly viewed unless viewed in a bright location because the reproduction beam is irradiated from the side where the viewer is positioned. For this reason, transmission type holograms that generate the reproduced image by irradiating the reproduction beam to the hologram from the side opposite the viewer are employed because the reproduced image is easy to see even in relatively dark locations.

However, for example, as shown in FIG. 14A, if a transmission type hologram is positioned perpendicular to the horizontal plane and the viewer views the diffracted light from a direction substantially perpendicular to the hologram (View Position 1), the reproduction beam is irradiated at an angle to the thickness direction of the hologram utilizing a light source (backlight) from behind the hologram. As a result, there is a problem where the hologram may at times appear transparent from the back side and the shape of the backlight can be seen. Further, depending on the position of the viewer, for example, if there exists a viewing position on the light path of the reproduction beam incident to the hologram (Viewing Position 2), there is a problem where the reproduction beam will directly enter the eyes of the viewer. This is particularly hazardous when a laser is used as the light source of the reproduction beam.

Further, for example, as shown in FIG. 14B, if a transmission type hologram is positioned parallel to the horizontal plane and the viewer views the diffracted light from a direction oblique to the hologram (View Position 1), the reproduction beam is irradiated from a direction perpendicular to the hologram utilizing a light source (backlight) from behind the hologram. As a result, as with the above-mentioned case where a transmission type hologram is positioned perpendicular to the horizontal plane, the shape of the backlight itself can be seen, and if there exists a viewing position on the light path of the reproduction beam incident to the hologram (Viewing Position 2), there is a problem where the reproduction beam will directly enter the eyes of the viewer.

As a method for preventing viewing of objects other than the intended reproduced image, as a display apparatus using a transmission type hologram, for example, Japanese Patent Application Laid-Open No. 07-234372 proposes utilization of a display apparatus provided with a light controlling member, in which an image formed on a transmission type hologram screen between the transmission type hologram and a display device can be seen from the viewer side, however, the display device cannot be seen.

However, the display apparatus described in the JP-A No. 07-234372 is only intended for the purpose of preventing the display device from being viewed when a display image on a display panel of the display device is imaged onto the hologram screen, diffracted, and shown to the viewer, and is intended for application to image display using a hologram screen. More specifically, there is no description on reproducing a transmission type hologram that does not require a display device and that does not form an image on a hologram screen.

Further, assuming that the light controlling member is provided and optical information recorded on a transmission type hologram is reproduced in the same manner as the display apparatus described in the JP-A No. 07-234372, there is a possibility that viewing the shape of the light source (backlight) itself can be prevented, however, it is not necessarily possible to prevent directly viewing the reproduction beam depending on the viewing position of the viewer.

It is desirable, therefore, to further develop a technique relating to an optical reproducing apparatus and an optical reproducing method that allow for suitably changing the design thereof depending on the arrangement aspect of a transmission type hologram and the viewing position of the transmission type hologram, depend little on the angle, prevent unnecessary objects from being viewed, and allow the reproduced image to be viewed safely.

### BRIEF SUMMARY OF THE INVENTION

The object of the present invention is to resolve the conventional problems and achieve the following objectives. More specifically, the object of the present invention is to provide an optical reproducing apparatus and an optical reproducing method for safely viewing a reproduced image by preventing the reproduction beam from the light source (backlight) from directly entering the eyes of the viewer depending on the visual position of the viewer when information holographically recorded on an optical recording medium, in particular, a transmission type hologram is reproduced.

The means for resolving the various conventional problems are described as follows.

The optical reproducing apparatus of the present invention is equipped with a recorded information reproducing unit configured to reproduce recorded information corresponding to an interference image, which has been formed on an optical recording medium having a recording layer to holographically record information thereon by irradiating the recording layer with an information beam and a reference beam, by irradiating the interference image with a reproduction beam that is the same as the reference beam used during recording the information corresponding to the interference image, and

a reproduction beam blocking unit configured to block the transmitted reproduction beam that is incident at a specific angle relative to the optical recording medium, and the reproduction beam blocking unit is placed between the viewing position of the reproduced recorded information and the optical recording medium.

In the optical reproducing apparatus, a reproduction beam that is the same as a reference beam used during recording is irradiated to an interference image which has been formed on an optical recording medium having a recording layer to holographically record information thereon by irradiating an information beam and the reference beam to thereby reproduce the recorded information corresponding to the interference image. The reproduction beam blocking unit is placed between the viewing position of the reproduced recorded image and the optical recording medium and blocks the reproduction beam transmitted through the optical recording medium after it is incident to a specific angle relative to the optical recording medium. With this configuration, it is possible to prevent the reproduction beam from the light source (backlight) from directly entering the eyes of the viewer depending on the viewing position of the viewer to allow the reproduced image to be viewed safely.

The optical reproducing method of the present invention includes reproducing recorded information corresponding to an interference image, which is formed on an optical recording medium having a recording layer to holographically record information thereon by irradiating the recording layer with an information beam and a reference beam, by irradiating the interference image with a reproduction beam that is the same as the reference beam used during recording the information, and blocking the transmitted reproduction beam that is incident at a specific angle relative to the optical recording medium at a position between the viewing position of the reproduced recorded information and the optical recording medium.

In the recorded information reproducing step of the optical reproducing method, an interference image, which has been formed on an optical recording medium having a recording layer to holographically record information thereon by irradiating the recording layer with an information beam and a reference beam, is irradiated with a reproduction beam that is the same as the reference beam used during recording the information corresponding to the interference image, thereby the recorded information is reproduced. In the reproduction beam blocking step, the reproduction beam is incident between the viewing position of the reproduced recorded information and the optical recording medium at a specific angle relative to the optical recording medium, and then the reproduction beam transmitted through the optical recording medium is blocked. As a result, it is possible to prevent the reproduction beam from the light source (backlight) from directly entering the eyes of the viewer depending on the viewing position of the viewer to allow the reproduced image to be viewed safely.

### BRIEF DESCRIPTION OF THE SEVERAL VIEWS OF THE DRAWINGS

FIG. 1 is a schematic diagram showing an example shape of a horizontal cross-section of a light transmissive area formed on a light blocking plate in the reproduction beam blocking unit of the present invention.

FIG. 2 is a schematic diagram showing an example of arrangement aspects of a light transmissive area formed on a light blocking plate in the reproduction beam blocking unit of the present invention.

FIG. 3A is a schematic diagram showing an example of a reproduction beam blocking unit when information recorded on an optical recording medium is a V hologram.

FIG. 3B is a schematic diagram showing an example of a reproduction beam blocking unit when information recorded on an optical recording medium is an H hologram.

FIG. 4A is a top view showing an example of a reproduction beam blocking unit consisting of a light blocking plate having light transmissive areas.

FIG. 4B is a cross-sectional view of the reproduction beam blocking unit shown in FIG. 4A.

FIG. 5 is a schematic diagram showing conditions under which the reproduction beam transmits through the light transmissive areas of the light blocking plate.

FIG. 6 is a cross-sectional view showing an example of a reproduction beam blocking unit consisting of a light blocking plate having light transmissive areas.

FIG. 7 is a cross-sectional view showing another example of a reproduction beam blocking unit consisting of a light blocking plate having light transmissive areas.

FIG. 8 is a schematic diagram showing an example of a reproduction beam blocking unit consisting of a light blocking plate having light transmissive areas.

FIG. 9 is a schematic diagram showing another example of a reproduction beam blocking unit consisting of a light blocking plate having light transmissive areas.

FIG. 10 is a schematic diagram showing an example of a reproduction beam blocking unit consisting of a light blocking plate having light transmissive areas consisting of a two-layer pattern.

FIG. 11 is a schematic diagram showing an example of a reproduction beam blocking unit formed from one light blocking plate having light transmissive areas consisting of a two-layer pattern.

FIG. 12A is a perspective view showing an example of a reproduction beam blocking unit consisting of one light blocking plate having light transmissive areas.

FIG. 12B is a cross-sectional view of the reproduction beam blocking unit shown in FIG. 12A.

FIG. 13 is a schematic diagram showing an optical reproduction unit having a reproduction beam blocking unit consisting of a light blocking plate having holes passing there through, which is used in Example 3.

FIG. 14A is a schematic diagram showing an example of a reproduction method of a conventional transmission type hologram (V hologram).

FIG. 14B is a schematic diagram showing an example of a reproduction method of a conventional transmission type hologram (H hologram).

### DETAILED DESCRIPTION OF THE INVENTION

### (Optical Reproducing Apparatus and Optical Reproducing Method)

The optical reproducing apparatus of the present invention is equipped with at least a recorded information reproducing unit and a reproduction beam blocking unit and is further equipped with other appropriately selected components when required.

The optical reproducing method of the present invention includes at least a recorded information reproducing step and a reproduction beam blocking step and further includes other appropriately selected steps when required.

The recorded information reproducing step can be suitably performed by the recorded information reproducing unit, and the reproduction beam blocking step can be suitably performed by the reproduction beam blocking unit. For this reason, the optical reproducing method of the present invention can be suitably carried out using the optical reproducing apparatus of the present invention, and when the optical reproducing apparatus of the present invention is used, then the optical reproducing method of the present invention is to be carried out.

Hereinafter, the optical reproducing apparatus of the present invention will be described in detail, and the details of the optical reproducing method of the present invention will also be described therethrough.

### <Recorded Information Reproducing Unit and Recorded Information Reproducing Step>

The recorded information reproducing unit has a function to irradiate an interference image, which has been formed on an optical recording medium having a recording layer to holographically record information thereon by irradiating the recording layer with an information beam and a reference beam, with a reproduction beam that is the same as the reference beam used during recording information corresponding to the interference image to thereby reproduce the recorded information, and the recorded information reproducing unit has at least a light source to emit the reproduction beam.

In the recorded information reproducing step, an interference image, which has been formed on an optical recording medium having a recording layer to holographically record information thereon by irradiating the recording layer with an information beam and a reference beam, is irradiated with a reproduction beam that is the same as the reference beam used during recording information corresponding to the interference image to thereby reproduce the recorded information.

The recorded information reproducing step can be suitably performed by the recorded information reproducing unit.

### —Information Beam and Reference Beam—

There are no particular restrictions on the information beam and the reference beam, so a suitable light source can be selected in accordance with the purpose; for example, lasers or light emitting diodes can be suitably used as these light sources, and white light sources such as bright xenon lamps and metal halide lamps can also be suitably used.

There are no particular restrictions on the laser light output by the lasers and the laser light can be selected in accordance with the purpose; for example, one or more wavelengths for the laser light could be selected from the wavelength range of 360 nm to 850 nm. It is desirable for the wavelength to be in the range of 380 nm to 800 nm, more preferable for the wavelength to be in the range of 400 nm to 750 nm, and most desirable for the wavelength to be the range of 500 nm to 600 nm, which is in the center of the visual spectrum that is most easily seen.

If the wavelength is less than 360 nm, it may be difficult to design the optical system, and if the wavelength exceeds 850 nm, the recording capacity may be reduced.

There are no particular restrictions on the information beam and reference beam irradiation method and a suitable irradiation method can be selected in accordance with the purpose; for example, a single laser beam can be output by the same light source and divided to irradiate the information beam and reference beam or two lasers can be output by different light sources to irradiate the information beam and reference beam.

The information is recorded by causing the information beam (object beam) and the reference beam to mutually interfere inside the optical recording medium and then writing the interference image (interference fringes) generated by this onto the optical recording medium.

### —Optical Recording Medium—

There are no particular restrictions on the optical recording medium and a suitable optical recording medium can be selected in accordance with the purpose; for example, an optical recording medium having at least a recording layer to holographically record information thereon on a support, and further having other layers suitably selected in accordance with necessity is exemplified.

The optical recording medium may be an optical recording medium in which information is recorded in two dimensions as a relatively thin flat hologram, etc. or may be an optical recording medium in which a large volume of information is recorded in a three-dimensional image, etc.

The optical recording medium may be a reflection type or transmission type, however, in view that the effect of preventing unnecessary objects from being viewed is remarkably exhibited in the present invention, a transmission type optical recording medium is preferable.

Further, the hologram recording method may have any of the aspects of, for example, an amplitude hologram, phase hologram, blaze hologram, complex amplitude hologram, etc.

The recording layer is formed of a material with optical properties such as the absorption coefficient or refractive index that are changed in accordance with the strength of an electromagnetic wave when the material is irradiated with the electromagnetic wave having a specified wavelength (gamma rays, X rays, ultraviolet rays, visible light, infrared light, radio waves, etc.) to thereby holographically record information.

There are no particular restrictions on the recording layer material and a suitable recording layer material can be selected in accordance with the purpose; for example, a photothermal conversion material, photosensitive plastic, binder, etc., and other components can be suitably selected when required.

There are no particular restrictions on the thickness of the recording layer and a suitable thickness can be selected in accordance with the purpose; for example, a range of 1 μm to 1,000 μm is preferable and a range of 100 μm to 700 μm is more preferable.

It is advantageous when the recording layer thickness is within the preferable value range because it allows a sufficient S/N ratio to be obtained.

### —Reproduction Beam—

The reproduction beam is the same beam as the reference beam, and the details regarding the reproduction beam are as described above for the reference beam.

For the reproduction beam, beams irradiated from conventional light sources can be preferably used.

For the light source to emit the reproduction beam, a light source is preferable which allows for irradiating a light beam having a wavelength which is included in the wavelength range of the reference beam used to form the interference image. For example, lasers and LED are preferably exemplified. Further, a white light, such as a xenon lamp or metal halide lamp with a high luminance, can also be used.

There are no particular restrictions on the irradiation method of the reproduction beam and a suitable irradiation method can be selected in accordance with the purpose, but it is preferable that it be performed using the same method used for irradiation of the reference beam. For example, if the reference beam is irradiated by parallel light, it is preferable that parallel light of the reproduction beam be irradiated, and if the reference beam is irradiated by a point light source, it is preferable that a pin light source be used to irradiate the reproduction beam.

Irradiation of the reproduction beam on the interference image generates reflected light having a strength distribution that corresponds to the optical property distribution formed within the recording layer as the image information corresponding to the interference image, which allows reproduction of recorded information based on the interference image.

<Reproduction Beam Blocking Unit and Reproduction Beam Blocking Step>

The reproduction beam blocking unit is placed between the viewing position of the reproduced recorded information and the optical recording medium. Further, the reproduction beam blocking unit has a function to block the reproduction beam that is incident at a specific angle relative to the optical recording medium and is transmitted through the optical recording medium.

The reproduction beam blocking step is a step to block the reproduction beam that is incident at a specific angle relative to the optical recording medium and is transmitted through the optical recording medium.

Further, the blocking of the reproduction beam in the reproduction beam blocking step can be suitably performed by the reproduction beam blocking unit.

There are no particular restrictions on the reproduction beam blocking unit as long as it can block the reproduction beam that is incident at a specific angle relative to the optical recording medium and is transmitted through the optical recording medium, and a suitable blocking unit can be selected in accordance with the purpose, however, suitable possibilities include (1) a unit consisting of multiple light blocking plates arranged in parallel, (2) the light blocking plates in (1) having at least some light transmissive area through which the reproduction beam can be transmitted, and (3) a single light blocking plate having at least some light transmissive area through which the reproduction beam can be transmitted with the light blocking plate positioned so that the light transmissive area is facing an optical recording medium.

### —Light Blocking Plate—

There are no particular restrictions on the light blocking plate and a suitable shape, construction, size, thickness, material, surface condition, color, etc., can be selected in accordance with the purpose.

It is preferable that the shape be a flat plate shape. The light blocking plate may be formed in a single layer structure or multilayered structure.

There are no particular restrictions on the thickness and a suitable thickness can be selected in accordance with the size of the light blocking plate, but when light transmissive areas are formed in the light blocking plate and the light blocking plate is large, the weight of the plate could cause it to deform, causing a distortion in the position relationship between the light transmissive areas of the light blocking plate and other adjacent light blocking plates, which would prevent sufficient realization of the light blocking function of the reproduction beam, so it is preferable that the light blocking plate be made thick. In contrast, if the thickness of the light blocking plate is too thick, it will increase the weight of the light blocking plate and could reduce handleability, so it is preferable that a suitable thickness for the size of the light blocking plate be provided.

Note that the thickness means the thickness of the light blocking plate itself when the light transmissive areas are holes, to be described hereinafter, through the light blocking plate, or the thickness of a transparent base when the light transmissive area is an opening in a pattern formed in the light blocking plate from the transparent base to be described hereafter.

In particular, for example, if the shape of the main surface of the light blocking plate is square and the diagonal line between opposite corners on the main surface is 100 mm, then it is preferable that the thickness be 1 μm to 10 mm. In this case, it is preferable that the lower limit value for the thickness be 10 μm and it is more preferable that it be 100 μm, and it is also desirable for the upper limit value to be 5 mm and it is more preferable for it to be 2 mm. Further, when the diagonal line is 1,000 mm, it is preferable that the thickness be 10 μm to 100 mm. In this case, it is preferable that the lower limit value for the thickness be 100 μm and it is more preferable that it be 1 mm, and it is also desirable for the upper limit value to be 50 mm and it is more preferable for it to be 20 mm.

If the sizes of the light blocking plates differ, it is preferable that the thickness be set within a value range proportional to them.

Further, if the shape of the main surface of the light blocking plate is other than square, if it is rectangular for example, then the length of the diagonal line is used. If it is a rhombus, the average of the long and short diagonal lines is used. If the shape is such that a diagonal line cannot be prescribed, the diameter of a supposed circle having the same surface area can be set as the reference for setting the thickness.

There are no particular restrictions on the material as long as the material can maintain the shape, and a suitable material can be selected, such as metal like aluminum, copper, stainless steel, or iron; glass; ceramic; wood; paper; plastic; etc.

Further, if the light blocking plate has a transparent base to be described hereafter, suitable examples thereof include transparent plastics and glass. Further, it is preferable that the surface of the transparent base be processed to prevent reflection to prevent light surface reflection and to improve transmittance.

Here, suitable materials for the plastic material include polycarbonate, PET, TAC, PMMA, vinyl chloride, etc.

For the surface condition it is preferable that the surface roughness be 0.01 μm to 10 μm and more preferable that it be 0.1 μm to 5 μm, for example.

If the surface roughness is less than 0.01 μm, the surface reflection may increase and it could become difficult to see the visual effect, and since the surface is flat and smooth, it is easier for a variety of matter to adhere to the surface, and if the surface roughness exceeds 10 μm, the gloss of the image may be reduced.

Further, it is preferable that the reflectance at the surface be 0.01% to 10% and more preferable that it be 0.1% to 5% for example.

If the reflectance is less than 0.01%, a complex anti-reflection layer must be formed during manufacture of the light blocking plate, which will not only increase the cost but could also lower the light irradiation durability, and if the reflectance exceeds 10%, the affect on the surface reflection could make the visual effect difficult to see.

The color of the light blocking plate is preferably black, considering that the light blocking plate absorbs the reproduction beam and can thus effectively block the reproduction beam, and even more preferable that it be a deglossed black. The color may be the color of the light blocking plate itself or the color may be given to the light blocking plate by coating, processing or the like.

### —Transmissive Area—

There are no particular restrictions on the light transmissive area as long as only the reproduction beam irradiated on the light recording medium at a fixed angle can pass therethrough, and a suitable shape, construction, size, etc., of the transmittance area can be selected.

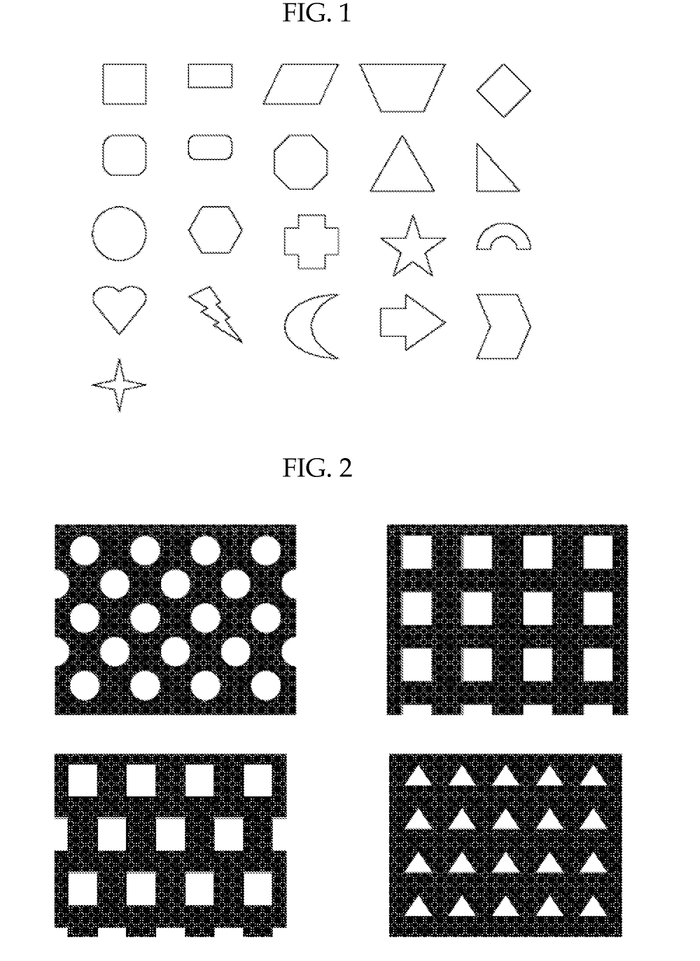

Examples of the shape include a flat cross-section shape; a polygonal shape such as a quadrangle, triangle, or pentagon; star; circle; oval; or a combination of these, and specific examples are shown in FIG. 1. These shapes can be used singularly or in a combination of two or more.

If the shape is a circle, a transmittance distribution that does not rely on angle can be obtained. Further, if the shape has angles, such as a polygon or star, the aperture will widen in the dependent direction of the angle, making it possible to relax the angle selectability for the direction. Further, changing the horizontal direction length (x) and vertical direction length (y) of the shape will tighten the angle selectability for the specified direction and relax the angle selectability for other directions, making it possible to control the angle selectability.

Further, the edge of the light transmissive area can be rounded or chamfered, etc. In this case, relaxing the angle selectability is possible.

The light transmissive areas can be regularly arranged at a regular interval or arrange randomly, and possibilities for the arrangement aspect include a lattice, checkered, random, and irregular patterns, for example.

For the light transmissive area arrangement aspect, the arrangement aspect shown in FIG. 2 is preferably exemplified.

There are no particular restrictions on the interval (pitch) among adjacent light transmissive areas when the light transmissive areas are regularly arranged at a regular interval and a suitable interval can be selected in accordance with the purpose; for example, a range of 1 μm to 100 mm is preferable and a range of 10 μm to 10 mm is more preferable.

If the interval (pitch) among the adjacent light transmissive areas is less than 1 μm, the size of the light transmissive areas is too small, so accurate manufacture may be difficult, and if it is more than 100 mm, a very large hologram image is required, and as the hologram image becomes larger, ability to handle it may be reduced and cost may be increased.

The light transmissive area construction could be through holes formed in the thickness direction of the light blocking plate or apertures in a pattern formed in a light blocking plate consisting of a transparent base.

The pattern can be formed by regular patterning including such as etching with chrome or other substance, injection pattern printing, and toner application using an electrophotographic apparatus, for example.

For the light transmissive area size, for example, it is preferable that the aperture diameter be 1 μm to 10 mm and more preferable that it be 10 μm to 1 mm.

If the aperture diameter is less than 1 μm, the size of the aperture diameter is too small, so accurate manufacture could be difficult, and if it is greater than 10 mm, a very large hologram image is required, and as the hologram image becomes larger, ability to handle it may be reduced and cost may be increased.

If the light transmissive area is the through hole, then it is preferable that the ratio of the through hole depth to the aperture diameter (aspect ratio: depth/aperture diameter) be 2 or more, more preferable that it be 2 to 100, and even more preferable that it be 4 to 20.

If the aspect ratio is less than 2, there is a possibility of almost no louver effect (reproduction beam blocking effect) being obtained. Further, if the aspect ratio exceeds 100, the reproduction beam loss will be too large.

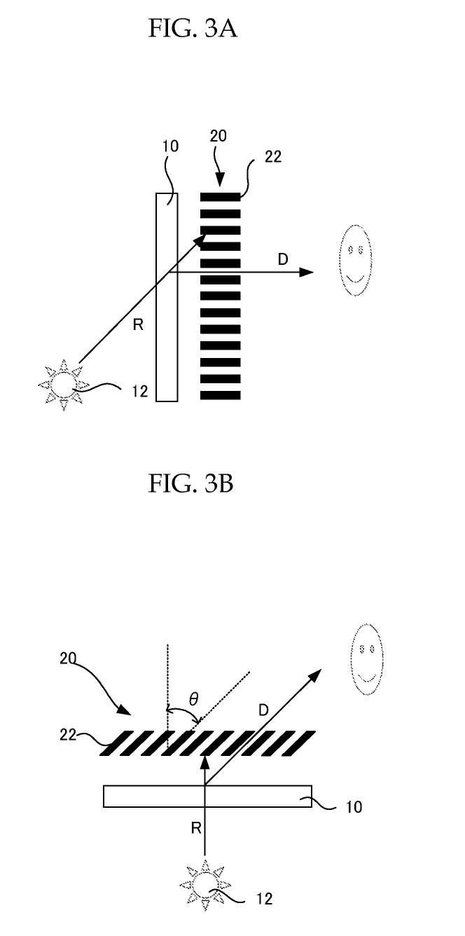

A possibility for the multiple light blocking plates arranged in parallel in (1) above, which is an example of the reproduction beam blocking unit, is the suitable aspect shown in FIG. 3A and FIG. 3B, for example.

The reproduction beam blocking unit 20 shown in FIG. 3A is a parallel arrangement of multiple light blocking plates 22 perpendicular to the main surface of the optical recording medium 10. Then, when the reproduction beam R from the light source (backlight) 12 is irradiated onto the optical recording medium 10, diffracted light D is generated, and only the diffracted light D that is incident from the direction perpendicular to the reproduction beam blocking unit 20 is transmitted between the light blocking plates 22, and the reproduction beam R that is incident at an angle to the thickness direction of the optical recording medium 10 is blocked by the light blocking plates 22. As a result, the viewer viewing the optical recording medium 10 from a perpendicular direction cannot see the shape of the light source 12 and the reproduction beam R cannot directly enter the eyes of the viewer even when viewing from any position.

Further, as shown in FIG. 3B, the multiple light blocking plates 22 can be arranged at an angle to the thickness direction of the optical recording medium 10. In this case, when the reproduction beam R from the light source (backlight) 12 is irradiated onto the optical recording medium 10, diffracted light D is generated, and only the diffracted light D that is incident from an angle to the reproduction beam blocking unit 20 is transmitted between the light blocking plates 22, and the reproduction beam R that is incident from the perpendicular direction of the optical recording medium 10 is blocked by the light blocking plates 22. As a result, the viewer viewing the optical recording medium 10 from an angle cannot see the shape of the light source 12 and the reproduction beam R cannot directly enter the eyes of the viewer even when viewing from any position.

Here, when the reproduction beam is irradiated to the optical recording medium at an angle to the optical recording medium by hanging the optical recording medium on a wall or placing it in a picture frame and when the viewer is viewing the optical recording medium from a substantially perpendicular direction (For example, the optical recording medium that is an aspect shown in FIG. 3A, which may be called a □V hologram□ hereinafter), it is preferable that the inclination angle of the light blocking plate to the thickness direction of the optical recording medium be within ±20° and it is more preferable that it be 0° (substantially perpendicular).

If the inclination angle exceeds ±20°, the light source (backlight) may be visible or the reproduction beam may directly enter the eyes.

Further, if the optical recording device is placed on a desk, the floor, etc., and the reproduction beam is irradiated from a direction perpendicular to the optical recording medium and the viewer is viewing from an angle to the optical recording medium (For example, the optical recording medium that is an aspect shown in FIG. 3B, which may be called an □H hologram□ hereinafter), it is preferable that the inclination angle of the light blocking plate to the thickness direction of the optical recording medium (θ shown in FIG. 3B) be greater than ±20° and within ±80°.

If the inclination angle is within ±20° and the optical recording medium (image) is viewed directly, the light source (backlight) could be seen or the reproduction beam could directly enter the eyes, and if it exceeds ±80°, the surface reflection of the support of the optical recording medium could reduce the amount of the reproduction beam irradiated onto the optical recording medium.

There are no particular restrictions on the number of the light blocking plates in the (1) reproduction beam blocking unit, and the number of the light blocking plates can be suitably selected in accordance with the width of the optical recording medium.

There are no particular restrictions on the arrangement interval among adjacent the light blocking plates as long as the reproduction beam is that is incident to the optical recording medium and is transmitted through the same and it is possible to selectively allow the diffracted light generated at an angle other than the specified angle to be transmitted through the optical recording medium and a suitable selection satisfying the objective can be made, and the interval between a certain light blocking plate and another light blocking plate adjacent to the certain light blocking plate, and the interval between the other light blocking plate and a light blocking plate adjacent to the other light blocking plate to be mutually the same or it can be different, but it is preferable for it to be mutually the same to uniformly block the reproduction beam that is incident at a set angle to the optical recording medium had has been transmitted through the same.

In this case, it is preferable for the arrangement interval among the light blocking plates to be 1 μm to 100 mm and more preferable that it be 10 μm to 10 mm, for example.

If the arrangement interval is less than 1 μm, the arrangement interval is too small, so accurate manufacture of the light blocking plate could be difficult, and if it is more than 100 mm, a very large hologram image is required, and as the hologram image becomes larger, ability to handle it could decline and cost could increase.

Specific examples of such a reproduction beam blocking unit that can be suggested include objects with such shapes as louvers or a window shades. Note that in the case of an object with the shape of window shades, if each fin has a sufficient strength, there is no need for a bowed fin shape as with regular window shades, and straight line fines can be preferably used.

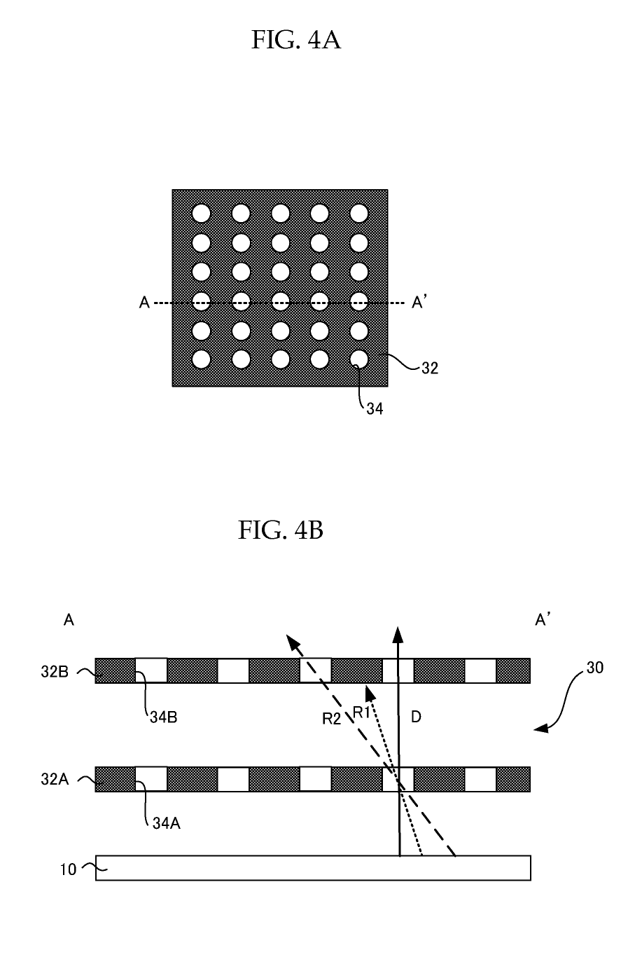

A possibility for the multiple light blocking plates arranged in parallel in (2) above, which is an example of the reproduction beam blocking unit, is the suitable aspect shown in FIG. 4A and FIG. 4B, which also have at least one light transmissive area through which the reproduction beam can be transmitted, for example. FIG. 4A shows a top view of the reproduction beam blocking unit, and FIG. 4B shows a cross-sectional view of the reproduction beam blocking unit.

The reproduction beam blocking unit 30 shown in FIG. 4A and FIG. 4B has light blocking plate 32, and the light blocking plate 32 is formed with through holes 34 in multiple the light transmissive areas in the thickness direction of the light blocking plate, and the through holes 34 are regularly arranged at a regular interval. Further, two light blocking plates 32 are arranged in parallel in a position parallel to the main surface of the optical recording medium 10 and are positioned such that the center of through hole 34A in a certain light blocking plates 32A and the center of through hole 34B in another light blocking plate 32B positioned adjacent to the certain light blocking plate 32A are nearly the same in the horizontal direction. In this case, it is possible to partially transmit the diffracted light and partially block the reproduction beam. Further, as shown in FIG. 4B, the diffracted light D that travels straight to a light blocking plate 32A from the optical recording medium 10 and is transmitted through the through holes 34A and 34B and seen by the viewer. In the meanwhile, the reproduction beam R1 that is incident to a light blocking plate 32A at an angle is transmitted through the through hole 34A and is then blocked by the sites in another light blocking plate 32B other than through hole 34B. Note that if the incident angle is too large as in the case of reproduction beam R2, the reproduction beam could be transmitted through the through hole 34B and adjacent through hole 34B of another light blocking plate 32B.

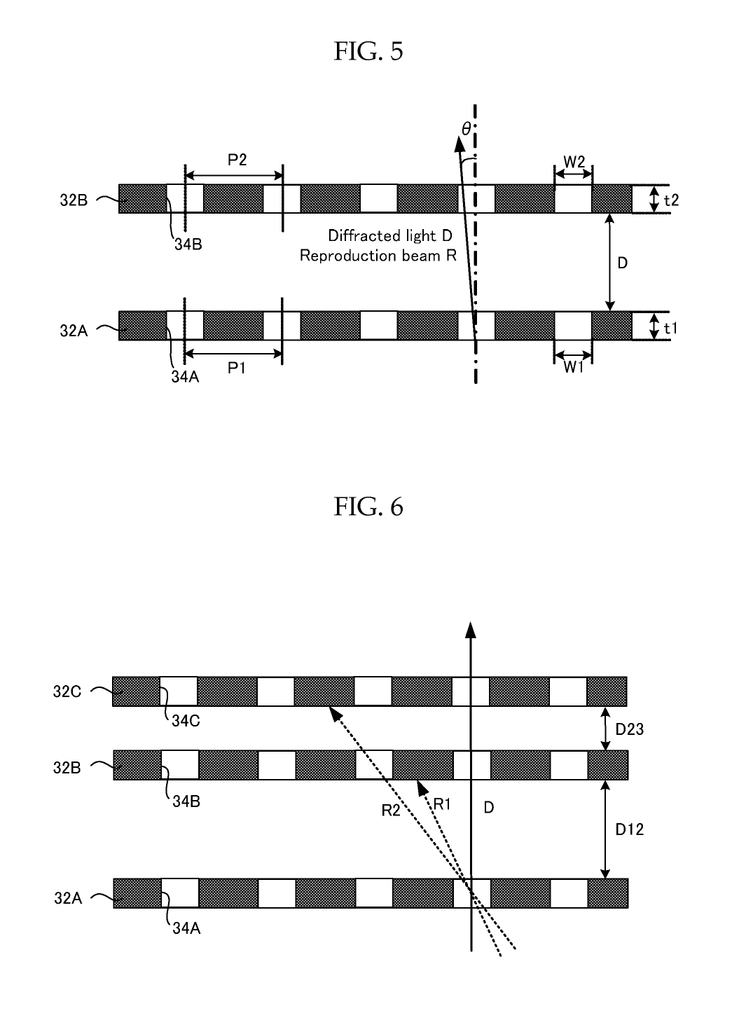

Here, the conditions under which the diffracted light is transmitted through the light transmissive area (the through hole) and the reproduction beam is blocked are explained in FIG. 5. As shown in FIG. 5, the pitch of through hole 34A of a certain light blocking plate 32A is P1, the aperture diameter of the through hole 34A is W1, the thickness of a light blocking plate 32A is t1 and the pitch of through hole 34B of another light blocking plate 32B positioned adjacent to the light blocking plate 32A is P2, the aperture diameter of the through hole 34B is W2, the thickness of the other light blocking plate 32B is t2. Also, making the angle of the diffracted light D and reproduction beam R that is transmitted through the center of the through hole 34A of the diffracted light D or reproduction beam R incident surface to be θ makes it possible to prescribe the transmission states of diffracted light D and reproduction beam R using the formulas in (1) to (3) below.

tan θ≦(W2/2)/(t1+D+t2) Formula (1)

(W2/2)/(t1+D+t2)<tan θ<(P2−W2/2)/(t1+D) Formula (2)

(P2−W2/2)/(t1+D)≦tan θ≦(P2+W2/2)/(t1+D+t2) Formula (3)

However, in the formula (3), tan θ≦(W1/2)/t1, (P2+W2/2)/(t1+D+t2)≦(P2−W2/2)/(t1+D).

When the incident angle θ of the diffracted light D satisfies the formula (1), the diffracted light D that is incident at a substantially perpendicular angle to the through hole 34A of a certain light blocking plate 32A is transmitted through the through hole 34B of another light blocking plate 32B in the perpendicular direction.

When the incident angle θ of the reproduction beam R satisfies the formula (2), the reproduction beam R that is incident at an angle to the through hole 34A of a certain light blocking plate 32A is blocked by the sites other than the through hole 34B of another light blocking plate 32B.

When the incident angle θ of the reproduction beam R satisfies the formula (3), the diffracted light D that is incident at a substantially perpendicular angle to the through hole 34A of a certain light blocking plate 32A is transmitted through the through hole 34B of another light blocking plate 32B in the perpendicular direction, and the reproduction beam R that is incident at an angle to the through hole 34A of a certain light blocking plate 32A is transmitted through the through hole 34B of another light blocking plate 32B at an angle. More specifically, when the incident angle θ satisfies the conditions of the formula (3), not only the diffracted light D that is originally intended to be transmitted through but the reproduction beam R that is incident at an angle is also transmitted through. When the range in which the optical recording medium (hologram) can be viewed is limited, it is not a problem if part of the reproduction beam is transmitted through away from the perpendicular direction in this manner, but if the inclination angle from which the hologram is viewed is large, then a design in which the formula (3) is not satisfied is desirable. More specifically, when the incident angle θ in the formula (3) is

tan θ>(W1/2)/t1, and (P2+W2/2)/(t1+D+t2)<(P2−W2/2)/(t1+D),

then a design that satisfies at least one of these is desirable.

Further, there are no restrictions in particular on the number of the light blocking plates as long as there are multiple plates and a number can be suitably selected in accordance with the purpose, but three or more light blocking plates are desirable so as to effectively block the reproduction beam when the incident angle to the light transmissive area is large.

Further, there are no restrictions in particular on the arrangement interval among adjacent the light blocking plates and a suitable selection satisfying the objective can be made, and the interval between a certain light blocking plate and another light blocking plate adjacent to the certain light blocking plate, and the interval between the other light blocking plate and a light blocking plate adjacent to the other light blocking plate to be mutually the same or it can be different, but it is preferable for it to be mutually different to effectively block the reproduction beam that is incident at a large angle.

More specifically, as shown in FIG. 6 for example, three light blocking plates having through holes for the light transmissive areas are arranged in parallel so that the arrangement interval among adjacent light blocking plates is different. Here, the arrangement is made so that the interval D12 between the first light blocking plate 32A and the second light blocking plate 32B is larger than the interval D23 between the second light blocking plate 32B and the third light blocking plate 32C.

In this case, the diffracted light D perpendicularly incident to the through hole 34A of the first light blocking plate 32A is transmitted perpendicularly through the through holes 34B and 34C of the second light blocking plate 32B and the third light blocking plate 32C, respectively. Further, the reproduction beam R1 that is incident at an angle to the through hole 34A of the first light blocking plate 32A is blocked by all sites other than the through hole 34B of the second light blocking plate 32B. Further, while the reproduction beam R2 that is incident at an angle larger than the reproduction beam R1 to the through hole 34A of the first light blocking plate 32A is incident at an angle to the through hole 34B of the second light blocking plate 32B and is transmitted through the through hole 34B, it is blocked by all sites other than the through hole 34C of the third light blocking plate 32C. As a result, only the diffracted light D perpendicularly incident to the optical recording medium (hologram) can be transmitted through and reproduction beams R1 and R2 that are incident at an angle can be effectively blocked.

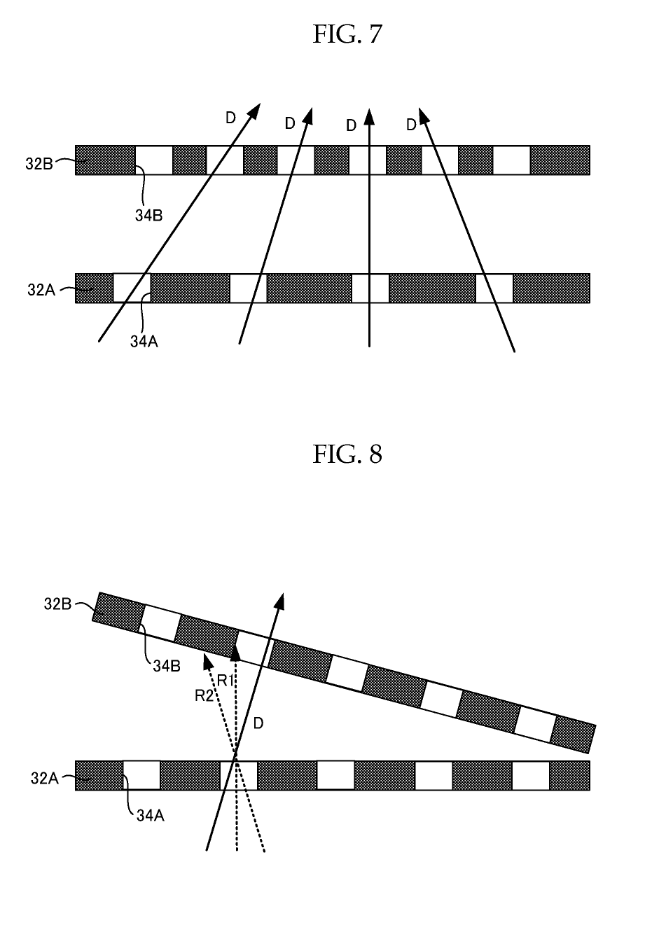

Further, as shown in FIG. 7, it is allowable for the distance between a certain light blocking plate 32A and the adjacent light transmissive area (through hole) (pitch P1 of through hole 34A) and the distance between another light blocking plate 32B and the adjacent light transmissive area (through hole) (pitch P2 of through hole 34B) to be different. In this case, the center position of through hole 34A of a certain light blocking plate 32A and the center position of through hole 34B of another light blocking plate 32B that is positioned adjacent to the certain light blocking plate 32A can be made to differ in the horizontal direction to focus on a point the diffracted light D transmitted through the through hole 34B of another light blocking plate 32B.

The above described aspects are mainly for when the viewer views the V hologram from the perpendicular direction with the objective of blocking the reproduction beam that is incident at an angle, but when the viewer views the H hologram from an angle, the objective is to block only the reproduction beam that is incident from the perpendicular direction, suggesting the possible aspects shown below, for example.

For example, as shown in FIG. 8, at least one of the light blocking plates can be arranged at an angle to the thickness direction of the optical recording medium. If two of the light blocking plates are arranged, positioning the certain light blocking plate parallel to the main surface of the optical recording medium and the other light blocking plate at an angle to the thickness direction of the optical recording medium makes it possible to offset the angle range in which the diffracted light or the reproduction beam is transmitted through the light transmissive area (the through hole) from the range symmetrical to the perpendicular direction. More specifically, for light that was transmitted through the through hole 34A of a certain light blocking plate 32A, relative to the reproduction beam R1 that was incident to the through hole 34A from the perpendicular direction, it is difficult for the reproduction beam R2 traveling in one side (left side in FIG. 8) to pass through the through hole 34B, and relative to the reproduction beam R1, it is easy for the diffracted light D traveling to another side (right side in FIG. 8) to pass through the through hole 34B. For this reason, suitably selecting the inclination angle to the light blocking plate makes it possible to effectively block the reproduction beam.

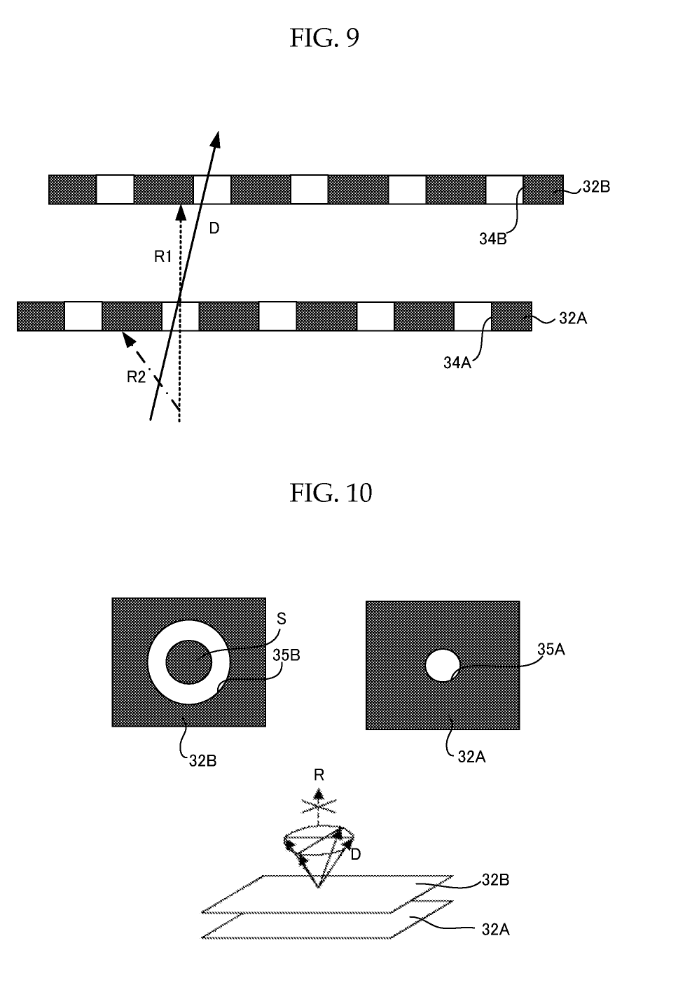

Further, the center position of the light transmissive area of the certain light blocking plate and the center position of the light transmissive area of another light blocking plate positioned adjacent to the certain light blocking plate can be different in the horizontal direction. As shown in FIG. 9 for example, if the center positions of the light transmissive areas (through holes) 34A and 34B of a certain light blocking plate 32A and another light blocking plate 32B, respectively, are positioned offset from each other, the angle range in which the diffracted light D or the reproduction beam R pass through the through holes 34A and 34B can be offset from the relative range relative to the perpendicular direction. As a result, the reproduction beam R1 that was incident from the perpendicular direction is blocked by all sites of the other light blocking plate 32B except the through hole 34B, and the reproduction beam R2 that was incident at a relatively large angle is blocked by all sites of the certain light blocking plate 32A except the through hole 34A so that only the diffracted light D that was incident at a specific angle from an oblique direction (an angle smaller than the reproduction beam R2 incident angle) can pass through the through hole 34B of the other light blocking plate 32B.

Further, making the horizontal cross-section shape of the light transmissive area of the certain light blocking plate different from the horizontal cross-section shape of the light transmissive area of another light blocking plate positioned adjacent to the certain light blocking plate makes it possible to allow just the diffracted light incident to the light transmissive area from an oblique direction to pass through. As shown in FIG. 10, for example, a light transmissive area 35A in a disc pattern is formed in a certain light blocking plate 32A made of the transparent base, a light transmissive area 35B in a doughnut double circle pattern is formed in another light blocking plate 32B made of the transparent material, and these light blocking plates 32A and 32B are arranged in parallel so that they are parallel to the main surface of the optical recording medium (hologram). In so doing, the reproduction beam R traveling straight passes through the through hole 35A of the certain light blocking plate 32A and is then blocked by the blocking area S positioned on the inside of that doughnut shaped light transmissive area 35B of the other light blocking plate 32B. Also, the diffracted light D incident from an oblique direction passes through the doughnut shaped light transmissive area 35B of the other light blocking plate. This makes it possible to allow only the diffracted light that was incident from an oblique direction to pass through. Note that the path of the diffracted light D that passed through forms a conic surface.

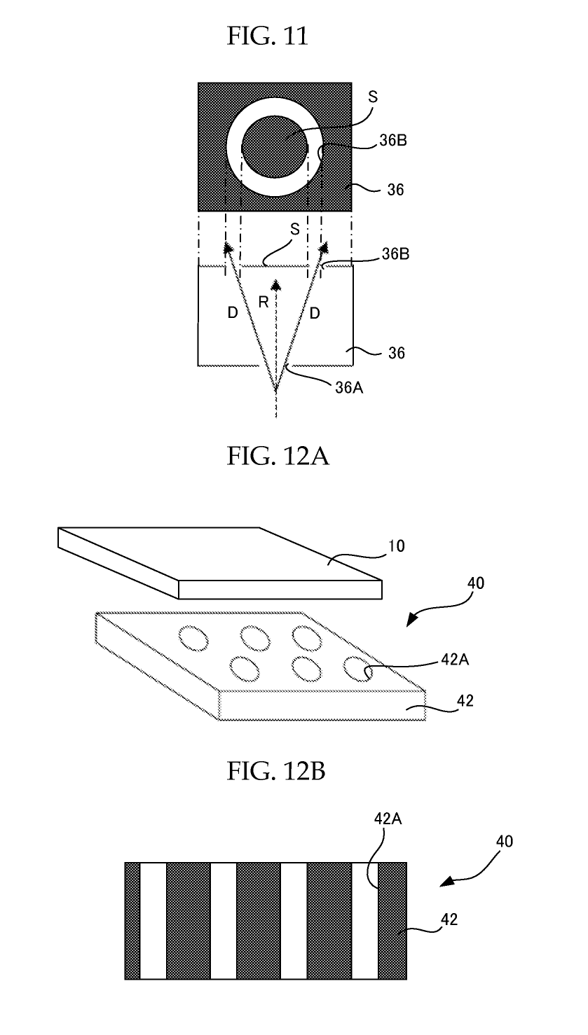

In the same way, a light transmissive area formed using the double pattern (aperture comparable to the pattern) can also be formed using the certain light blocking plate. As shown in FIG. 11 for example, a light transmissive area 36A is formed using a disc pattern in a main surface (back) of one light blocking plate 36 made of the transparent material and a light transmissive area 36B is formed using a doughnut double circle pattern in another main surface (front) of the light blocking plate 36. Then, the surface (back) formed by the light transmissive area 36A in the light blocking plate 36 is positioned opposite to the optical recording medium. In this case, the light blocking area S positioned on the inside of the light transmissive area 36B in the light blocking plate 36 blocks the reproduction beam R that is traveling straight and allows the diffracted light D that was incident from an oblique direction at a set angle to pass through. Note that the path of the diffracted light D that passed through forms a conic surface. Further, the aspect shown in FIG. 11 is comparable to the reproduction beam blocking unit described in (3) above.

Further, the light transmissive area that allows reproduction beam to pass through in (3) above, which is an example of the reproduction beam blocking unit, has a light blocking plate in at least one area and the light blocking plate is positioned so that the light transmissive area is facing the optical recording medium to suggest such possible aspects as those shown in the perspective view in FIG. 12A and the cross-sectional view in FIG. 12B, for example.

The reproduction beam blocking unit 40 shown in FIG. 12A and FIG. 12B has a light blocking plate 42 in which multiple through holes 42A are formed as the light transmissive areas in the thickness direction of the light blocking plate 42, and the through holes 42A are arranged so that they face the main surface of the optical recording material 10. In this case, it is possible for only the diffracted light that was incident from the perpendicular direction relative to the light transmissive areas (through holes) passes through while the reproduction beam that was incident from an oblique direction relative to the through holes is blocked and thus allowing suitable use of the H hologram.

Note that it is preferable to set the thickness of the light blocking plate 42 to be set larger relative to the light blocking plate 32 as an aspect of the (1).

In accordance with the optical reproducing apparatus and optical reproducing method of the present invention, when a transmission type hologram is reproduced, the reproduction beam from the light source (backlight) is prevented from directly entering the eyes of the viewer depending on the viewing position of the viewer to allow the reproduced image to be viewed safely. For this reason, the optical reproducing apparatus and the optical reproducing method of the present invention can be preferably used to reproduce 3D images to be formed in display devices, street advertisements, store front advertisements, and other applications using holograms.

### EXAMPLES

The present invention will be further described in detail with reference to specific Examples and Comparative Examples, however, the present invention is not limited to the disclosed Examples.

### Example 1

### Recording of Information on Optical Recording Medium

A silver salt film for hologram used as an optical recording medium was irradiated with an information beam and a reference beam to record information on a recording layer formed in the optical recording medium as an interference image. The optical recording medium was irradiated with an incident angle set at 45° to the optical recording medium.

### <Reproduction of Recorded Information>

As shown in FIG. 3A, the optical recording medium (transmission type hologram) 10 that was subject to the recording was placed perpendicularly on a desk. Next, louvers 20 serving as the reproduction beam blocking unit was positioned between the transmission type hologram 10 and the viewing position of the viewer.

Here, the louvers 20 were fabricated so that fins 22 as the multiple light blocking plates had a thickness of 10 mm using a black paper as the material and were arranged at an interval of 10 mm and formed in parallel to each other and perpendicular to the thickness direction of the transmission type hologram 10.

Next, a xenon lamp was used as the backlight 12 for the light source to emit the reproduction beam in the recorded information reproducing unit, and then the transmission type hologram 10 was irradiated with a reproduction beam R that was the same as the reference beam from the same direction as was the reference beam, more specifically, at an incident angle of 45° to the transmission type hologram 10 to generate diffracted light (reproduced image) D from the recorded interference image. The transmission type hologram 10 was then viewed from a horizontal direction. As a result, the backlight could not be seen and the reproduction beam R could not be seen from any position.

### Comparative Example 1

The information recorded as the transmission type hologram was reproduced, and the reproduced image was viewed in the same manner as in Example 1, except that no louvers were provided

As a result, the backlight was brightly viewed depending on the angle at which the hologram was viewed.

### Example 2

A silver salt film for hologram used as an optical recording medium was irradiated with an information beam and a reference beam to record information on a recording layer formed in the optical recording medium as an interference image. The optical recording medium was irradiated from the perpendicular direction to the optical recording medium.

### <Reproduction of Recorded Information>

As shown in FIG. 3B, the optical recording medium (transmission type hologram) 10 that was subject to the recording was placed horizontally. Next, louvers 20 serving as the reproduction beam blocking unit was positioned between the transmission type hologram 10 and the viewing position of the viewer.

Here, louvers 20 were fabricated so that fins 22 as the multiple light blocking plates had a thickness of 10 mm using a black paper as the material and were arranged in parallel to each other at an inclination angle θ of 45° to the transmission type hologram 10.

Next, a xenon lamp was used as the backlight 12 for the light source to emit the reproduction beam in the recorded information reproducing unit, and then the transmission type hologram 10 was irradiated with a reproduction beam R that was the same as the reference beam from the same direction as was the reference beam, more specifically, from the perpendicular direction to the transmission type hologram 10 to generate diffracted light (reproduced image) D from the recorded interference image. The transmission type hologram 10 was then viewed from the position of an inclination angle of 45° to the thickness direction of the transmission type hologram 10. As a result, the backlight could not be seen and the reproduction beam R could not be seen from any position.

### Comparative Example 2

The information recorded as the transmission type hologram was reproduced, and the reproduced image was viewed in the same manner as in Example 2, except that no louvers were provided

As a result, the backlight was brightly viewed depending on the angle at which the hologram was viewed.

### Example 3

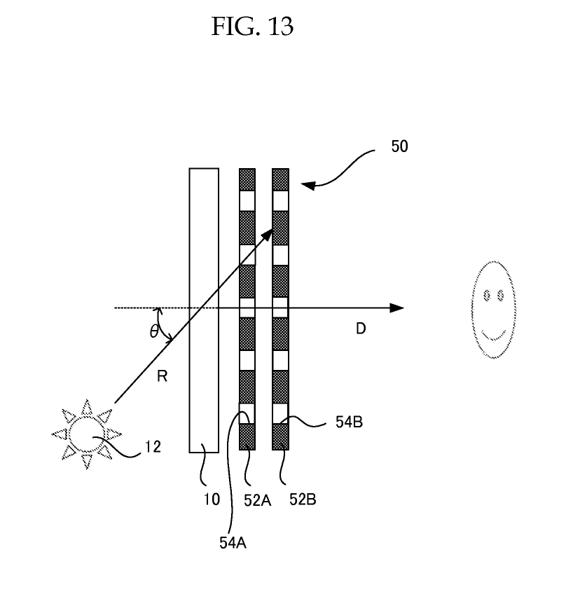

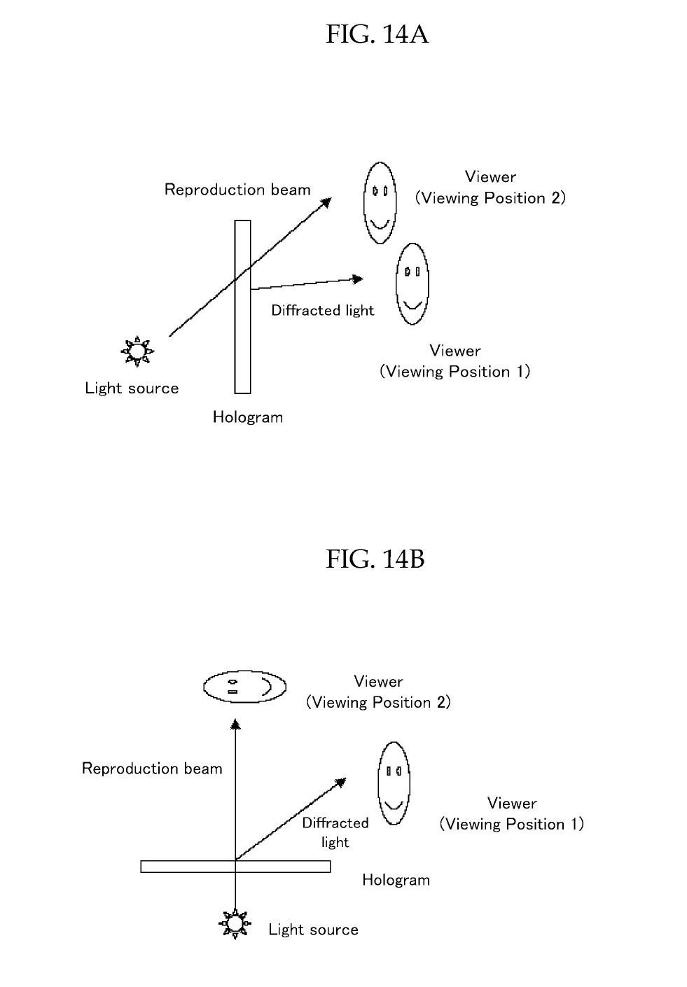

The information recorded as the transmission type hologram was reproduced, and the reproduced image was viewed in the same manner as in Example 1, except that the louvers as the reproduction beam blocking unit in Example 1 were changed to the reproduction beam blocking unit shown in FIG. 13.

As shown in FIG. 13, the reproduction beam blocking unit 50 of Example 3 had two light blocking plates 52 arranged in parallel and the respective through holes 54 as the light transmissive areas were formed in a regular arrangement at a regular interval in the thickness direction of the light blocking plates 52. Further, the center position of the through hole 54A of a certain light blocking plate 52A and the center position of the through hole 54B of another light blocking plate 52B positioned adjacent to the certain light blocking plate 52A were arranged nearly the same in the horizontal direction.

Further, the thicknesses of the certain light blocking plate 52A and the other light blocking plate 52B were both 10 mm and the arrangement interval of these light blocking plates was 10 mm. The aperture diameter of the through holes 54A and 54B in the certain light blocking plate 52A and the other light blocking plate 52B was 1 mm, the ratio of the depth to the aperture diameter (aspect ratio) of the through holes was 10, and the interval (pitch) between through holes was 2 mm.

Then, a xenon lamp was used as the backlight 12 for the light source, and then reproduction beam R that was the same as the reference beam was irradiated at the transmission type hologram 10 from the same direction as was the reference beam, more specifically, at a perpendicular direction relative to the transmission type hologram 10 to generate the diffracted light (reproduced image) D from the recorded interference image.

At that time, as shown in FIG. 13, the diffracted light D that traveled straight to a certain light blocking plate 52A passed through the through holes 54A and 54B and was seen by the viewer. In the meanwhile, the reproduction beam R1 that was incident to the certain light blocking plate 52A at an angle was blocked by the sites other than through holes 54B of the other light blocking plate 52B. As a result, when viewing from the perpendicular direction relative to the thickness direction of the transmission type hologram 10, the reproduced image D could be seen but the backlight could not be seen and the reproduction beam R could not be seen from any position.

The present invention provides an optical reproducing apparatus and an optical reproducing method that can resolve conventional problems and allow for safely viewing a reproduced image by preventing the reproduction beam from the light source (backlight) from directly entering the eyes of the viewer regardless of the position of the visual position of the viewer when information recorded on an optical recording medium using holography, and in particular a transmission type hologram, is reproduced.

The optical reproducing apparatus and optical reproducing method of the present invention, when a transmission type hologram is reproduced, prevents the reproduction beam from the light source (backlight) from directly entering the eyes of the viewer depending on the viewing position of the viewer to allow the reproduced image to be viewed safely. This allows suitable use in reproducing 3D images in display devices, street advertisements, store front advertisements, and other applications using holograms.

What is claimed is:

1. An optical reproducing apparatus, comprising:
a recorded information reproducing unit configured to reproduce recorded information corresponding to an interference image, which has been formed on an optical recording medium having a recording layer to holographically record information thereon by irradiating the recording layer with an information beam and a reference beam, by irradiating the interference image with a reproduction beam that is the same as the reference beam used during recording the information corresponding to the interference image, and
a reproduction beam blocking unit configured to block the transmitted reproduction beam that is incident at a specific angle relative to the optical recording medium, and the reproduction beam blocking unit is placed between the viewing position of the reproduced recorded information and the optical recording medium.

2. The optical reproducing apparatus according to claim 1, wherein information recorded on the optical recording medium is a transmission type hologram.

3. The optical reproducing apparatus according to claim 1, wherein the reproduction beam blocking unit comprises a plurality of light blocking plates arranged in parallel.

4. The optical reproducing apparatus according to claim 3, wherein the interval between a certain light blocking plate and another light blocking plate adjacent to the certain light blocking plate and the interval between that another light blocking plate and a still another light blocking plate adjacent to that another light blocking plate are nearly the same.

5. The optical reproducing apparatus according to claim 4, wherein the arrangement interval between the adjacent light blocking plates is 1 μm to 100 mm.

6. The optical reproducing apparatus according to claim 3, wherein at least one of the light blocking plates is arranged at an angle relative to the thickness direction of the optical recording medium.

7. The optical reproducing apparatus according to claim 6, wherein the inclination angle of at least one of the light blocking plates relative to the thickness direction of the optical recording medium is within ±20°.

8. The optical reproducing apparatus according to claim 6, wherein the inclination angle of at least one of the light blocking plates relative to the thickness direction of the optical recording medium is greater than ±20° and within ±80°.

9. The optical reproducing apparatus according to claim 3, wherein each of the light blocking plates has a light transmissive area that is transmissive to the reproduction beam, at least part thereof.

10. The optical reproducing apparatus according to claim 9, wherein the light transmissive area is a through hole formed in the thickness direction of each of the light blocking plate.

11. The optical reproducing apparatus according to claim 9, wherein the aperture diameter of the light transmissive area is within the range of 1 μm and 10 mm.

12. The optical reproducing apparatus according to claim 9, wherein the light transmissive areas are regularly arranged at a regular interval.

13. The optical reproducing apparatus according to claim 12, wherein the interval between the adjacent light transmissive areas is 1 μm to 100 mm.

14. The optical reproducing apparatus according to claim 10, wherein the ratio of the through hole depth to the aperture diameter is 2 or more.

15. The optical reproducing apparatus according to claim 1, wherein the reproduction beam blocking unit is louvers.

16. The optical reproducing apparatus according to claim 3, wherein the light blocking plate has a thickness of 1 μm to 100 mm.

17. The optical reproducing apparatus according to claim 3, wherein the color of the light blocking plate is black.

18. An optical reproducing method, comprising:
reproducing recorded information corresponding to an interference image, which has been formed on an optical recording medium having a recording layer to holographically record information thereon by irradiating the recording layer with an information beam and a reference beam, by irradiating the interference image with a reproduction beam that is the same as the reference beam used during recording the information, and
blocking the transmitted reproduction beam that is incident at a specific angle relative to the optical recording medium at a position between the viewing position of the reproduced recorded information and the optical recording medium.

19. The optical reproducing method according to claim 18, wherein information recorded on the optical recording medium is a transmission type hologram.

20. The optical reproducing method according to claim 18, wherein the reproduction beam is blocked by a reproduction beam blocking unit positioned between the viewing position of the reproduced recorded information and the optical recording medium.
